(19) United States
(12) Patent Application Publication
(10) Pub. No.: US 2009/0213074 A1
(43) Pub. Date: Aug. 27, 2009

(54) SYSTEM FOR CONTROLLING ONE OR MORE COMPUTERS

(75) Inventor: Ching-Wei Cheng, Keelung (TW)

Correspondence Address: ROGER H. CHU, 19499 ERIC DRIVE, SARATOGA, CA, 95070, US

(73) Assignee: ACTION STAR ENTERPRISE CO., LTD., Sijhih (TW)

(21) Appl. No.: 12/037,293

(22) Filed: Feb. 26, 2008

(51) Int. Cl. G06F 3/033

(52) U.S. Cl. 345/163

(57) ABSTRACT

A system for controlling one or more computers comprises one or more host computers, a KVM (Keyboard/Video/Mouse) switching device and a computing device including a keyboard, a cursor control device, a video display unit and a data processing unit, wherein the KVM switching device includes a first driver coupled to the host computers; a video codec for converting video signals from the host computers to digital video signals; an USB (Universal Serial Bus) adapter for receiving the digital video signals and transferring the digital video signals to a second driver and receiving and transferring command signals between the first driver and the second driver bi-directionally; wherein the second driver couples to the computing device for receiving and transmitting the digital video signals and command signals between the computing device and the USB adapter; wherein the data processing unit manages the digital video signals converted from each of the plurality of host computers for simultaneously displaying the digital video signals on the video display unit.

### BACKGROUND OF THE INVENTION

(a) Field of the Invention

The present invention relates to a KVM (Keyboard, Video and Mouse) switching system for interconnecting one or more of computer user terminals each having user interface devices, including a keyboard, a video display unit, and a cursor control device or mouse, allowing a user to access any one or more of said computers from a single terminal, and more particularly, to a system for enabling a single user to control multiple computers at a single terminal simultaneously.

(b) Description of the Prior Art

There exist devices for interconnecting a single computer to multiple computers. For example, a keyboard/video/mouse (KVM) switch is a device that is generally connected to multiple computers in order to enable a single keyboard, video monitor and mouse to control each of the connected computers. In this way, a user may have access to multiple computers without having to invest in corresponding keyboards, monitors, and mice for each of the computers. When the user accesses a computer connected to the KVM switch, video signals are routed from the computer, processed, and displayed on the single video monitor. An original KVM switch 74 is shown in the block diagram of FIG. 1. Using commands from a keyboard 122, the user may switch between the several computers (100a through 100c). Internally, based on the selection, the KVM switch 74 establishes a set of three connections from the computer-interface side to the user-interface side. Accordingly, the output of the video card of one of the computers is displayed on the video monitor 120 when that computer is selected, and the signals from the keyboard 122 and the mouse 124 are directed to the selected computer as if the keyboard 122 and mouse 124 were directly connected to the selected computer.

When the user want to switch the output on the video monitor 120 from the first computer 100a to the second computer 100b, generally, the user must utilize pre-defined key sequences, such as <scroll-lock>, to release control over the first computer 100a, return control to the KVM switch 74, and navigate through an on-screen menu or other display in order to access the second computer 100b connected to the KVM switch 74. In some cases, rather than utilizing key sequences and on-screen menus or displays in order to be able to access another computer, the user must physically actuate a button or other mechanism on the KVM switch 74. But requiring a user to physically access the KVM switch 74 is adverse to the promotion of easy switching between computers, particularly if the KVM switch 74 is placed in an inconvenient, remote, or inaccessible location, for example. Regardless of how access to a particular computer is granted, for typical KVM switches 74, only the video output of the accessed computer is processed and displayed on video monitor 120. That is, a user is not able to view the video output from the other “non-accessed” computers connected to the KVM switch 74 because video output from the “accessed” computer covers the entire video display unit. Allowing a user to view and access one computer while also allowing the user to view the other “non-accessed” computers would not only provide greater information to the user, but would also provide the foundation for enabling quick and seamless navigation between all the computers.

U.S. Pat. No. 7,240,111, the contents of which are hereby incorporated by reference, discloses a KVM switching device for interconnecting a single user console having user interface devices to plurality of host computers. The KVM switching device manages the video signals transmitted from each of the plurality of host computers for simultaneously displaying video signals from at least two of the plurality of host computers on the user console video display unit. The KVM switching device includes a scaling module and a cropping module. The scaling module proportionally reduces the size of the host computer windows so that more than one host computer window may be visible at a given time. These scaled windows may be made larger or smaller according to the preference of the user. The cropping module removes portions of the host computer windows that cannot be seen due to any overlapping between windows. Moreover, The KVM switching device includes a ADC (Analog to Digital Converter) for converting the VGA (Video Graphics Array) signals from host computers to digital video signals and a DAC (Digital to Analog Converter) for converting the digital signals to analog signals for displaying on the user console video display unit. Adding ADC, DAC and the two modules in KVM switching devices will increase the manufacture cost of the KVM switching devices.

It is desirable, therefore, to provide a switching system that has an intuitive user interface to allow for easy interaction with one or more computers connected to the switching system and allow for the simultaneous output of video and audio from more than one of the computers without increasing the manufacture cost.

### SUMMARY OF THE INVENTION

It is an object of the present invention to enable a single user to control one or more host computers on a computing device simultaneously.

Another object of the present invention to enable a single user to view one or more host computers on a computing device simultaneously without increasing the manufacture cost.

According to a preferred embodiment, the present invention provides a system for controlling one or more computers comprises one or more of host computers, a KVM switching device and a computing device including a keyboard, a cursor control device, a video display unit and a data processing unit, wherein the KVM switching device includes a first driver coupled to the host computers; a video codec for converting video signals from the host computers to digital video signals; an USB (Universal Serial Bus) adapter for receiving the digital video signals and transferring the digital video signals to a second driver and receiving and transferring command signals between the first driver and the second driver bi-directionally; wherein the second driver couples to the computing device for receiving and transmitting the digital video signals and command signals between the computing device and the USB adapter; wherein the data processing unit manages the digital video signals converted from each of the plurality of host computers for simultaneously displaying the digital video signals on the video display unit.

The details and technology of the present invention are described below with reference to the accompanying drawings:

### BRIEF DESCRIPTION OF THE DRAWINGS

FIG. 1 is a block diagram of original KVM switch.

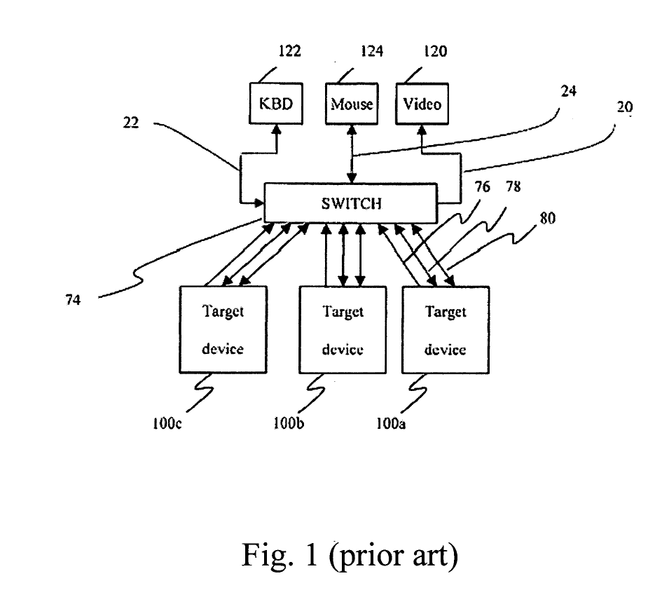

FIG. 2 is a diagram showing an exemplary system according to the invention.

FIG. 3 is an outward appearance diagram of the first driver according to the invention.

FIG. 4 is a diagram showing an exemplary layout of host windows on the video display unit.

FIG. 5 is a diagram showing an exemplary layout of host windows on the video display unit.

### DETAILED DESCRIPTION OF THE PREFERRED EMBODIMENTS

The present invention relates generally to a KVM switching system for enable a single user to view plurality of host computers on a computing device simultaneously. There are many products converted video signals (from VGA port, DVI (Digital Visual Interface) port, HDMI (High Definition Multimedia) port or display port) to USB signals for extending personal computers or portable computers having two display units. The concept is used in the KVM switching system of present invention.

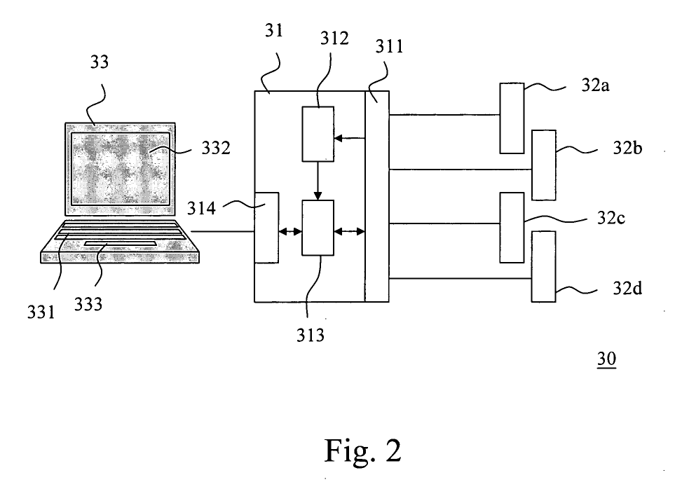

As shown in FIG. 2, the system 30 comprises a plurality of host computers 32a-32d, a KVM switching device 31 and a computing device 33 including a keyboard 331, a cursor control device 333, a video display unit 332 and a data processing unit (not shown). The KVM switching device 31 includes a first driver 311 coupled to the host computers 32a-32d; a video codec 312 for converting video signals from the host computers 32a-32d to digital video signals. The KVM switching device 31 also includes an USB adapter 313 for receiving the digital video signals and transferring the digital video signals to a second driver 314. The USB adapter 313 also receives and transfers command signals between the first driver 311 and the second driver 314 bi-directionally.

The second driver 314 couples to the computing device 33 for receiving and transmitting the digital video signals and command signals between the computing device 33 and the USB adapter 313 of the KVM switching device 31. The computing device 33 is a portable computer (notebook computer) with a built-in keyboard 331, a cursor control device 333, a video display unit 332 and a data processing unit (not shown). The data processing is used for operating and storing datum or application software. The data processing unit manages the digital video signals converted from each of the plurality of host computers 32a-32d for simultaneously displaying the digital video signals on the video display unit 332.The command signals comprise cursor control signals and keyboard input signals.

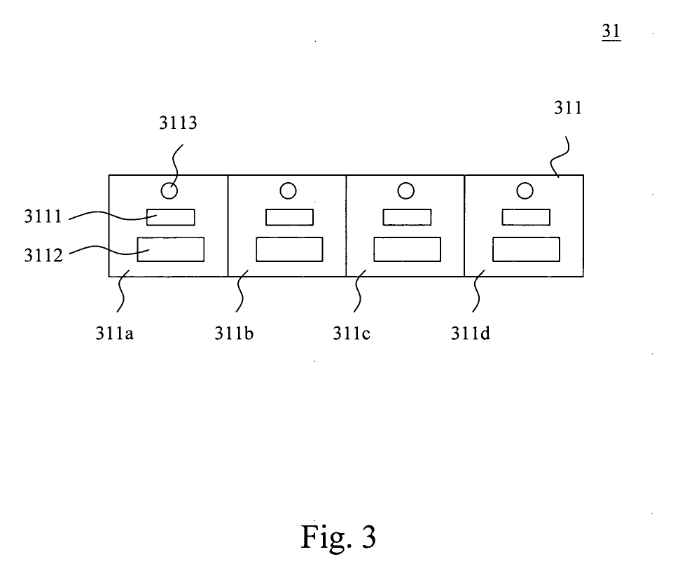

The outward appearance diagram of the first driver is shown in FIG. 3. The first driver 311 of the KVM switching device 31 comprises plurality group ports 311a-311d corresponding to the plurality of host computers 32a-32d (see FIG. 2) respectively. Each of the group ports 311a-311d includes at last one USB port 3111, a video input port 3112 and a audio input port 3113. After the host computers 32a-32d turned on, these host computers 32a-32d executes a self test procedure. The self test procedure tests if the hardware or software in the host computers 32a-32d failed or not, the necessary peripheral devices are ready or not, etc. The necessary peripheral devices are keyboard and cursor control device. If one of keyboard and cursor control device is not connected (by cable or wireless) to the host computers 32a-32d, the host computers 32a-32d will not be turned on. By connecting the USB port 3111 and the host computers 32a-32d, the keyboard 331 and cursor control device 333 of the computing device 33 are used to be necessary peripheral devices by the KVM switching device 31 connecting between the host computers 32a-32d and the computing device 33. Thus, the host computers 32a-32d will be turned on normally.

The video input port 3112 is a VGA port, a DVI port, a HDMI port or a display port. The video input port 3112 receives video signals from the host computers 32a-32d. If the video input port 3112 is a VGA port, the video signals from the host computers 32a-32d should be analog video signals. Therefore, the video codec 312 is functioned as an analog to digital converter for converting analog video signals to digital video signals. Also, if the video input port 3112 is a DVI port, a HDMI port or a display port, the video signals from the host computers 32a-32d should be digital video signals. Therefore, the video codec 312 converts the digital video signals from the host computers 32a-32d to USB compatible digital video signals.

After converting the video signals to digital video signals by the video codec 312 and transferring the digital video signals to the computing device 33 through the second driver 314, the digital video signals are displayed in “windows” on the video display unit 332 of the computing device 33.

Loudspeaker is not a necessary peripheral device of a host computer. If users want to listen audio signals as music, a loudspeaker should be extra added to connect with the original KVM switch as U.S. Pat. No. 7,240,111 shown. It is not convenient in use. The audio input port 3113 of the present invention receives the analog audio signals from the host computers 32a-32d. After converting the analog audio signals to digital audio signals by the video codec 312 and transferring the digital audio signals to the computing device 33 through the second driver 314, the digital audio signals will be broadcast by loudspeaker (not shown) built-in the computing device 33. Of course, the data processing unit of the computing device 33 will convert the digital audio signals to an acceptable format for broadcasting by the loudspeaker built-in the computing device 33.

The second driver 314 comprises at least one USB port for transmitting the digital video signals and digital audio signals and transmitting/receiving command signals (cursor control signal and keyboard input signal) between the computing device 33 and the host computers 32a-32d.

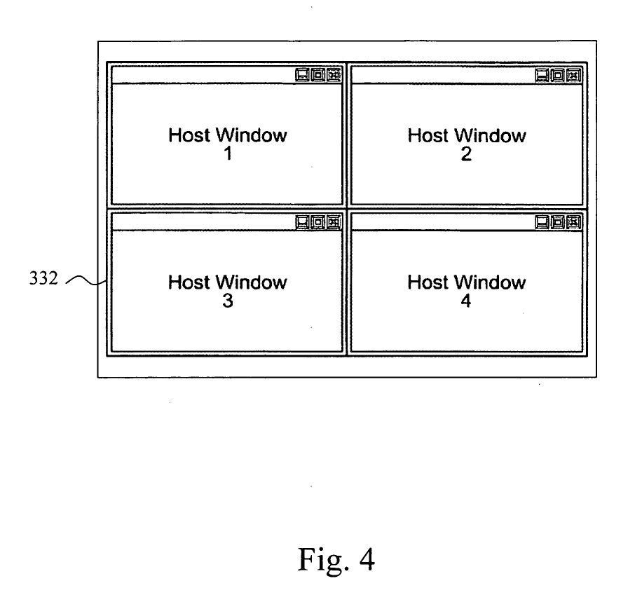

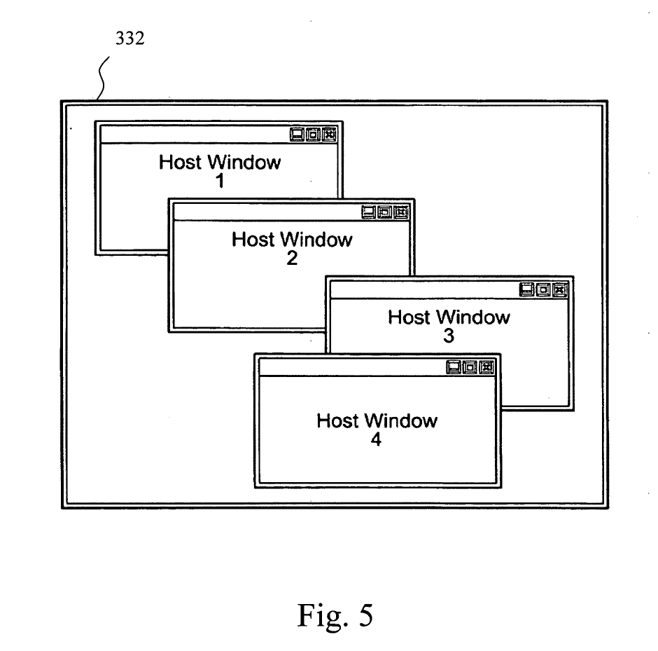

FIG. 4 shows an exemplary arrangement whereby each of the host computer windows are displayed on the video display unit 332. The digital video signals converted from analog video signals of the host computers are displayed in “windows” on the video display unit 332 of the computing device 33 respectively. In FIG. 5, for example, the host window 4 is fully visible while the host windows 1 through 3 are each at least partially covered. The size and position of each of the host window 1 to host window 4 displayed within the console video display unit 332 may be manipulated by the user. If the user wants to control a particular host computer, the user should move the cursor on the corresponding window of the video display unit 332 by controlling the cursor control device 333 of the computing device 33. For example, the user wants to control the host computer 32a, the user should move the cursor on the host window 1 of the video display unit 332 by controlling the cursor control device 333 of the computing device 33, the user could control the host computer 32a by the keyboard 331 and the cursor control device 333 of the computing device 33. Thus, system of the present invention enables a single user to control plurality of host computers on a computing device simultaneously.

After finishing the operating procedure of the system of the present invention, the user may take the computing device to other places individually for using. For example, as shown in FIG. 2, if the KVM switching device 31 and host computers 32a-32d are placed in office, different users may use their own computing devices 33 for controlling the host computers 32a-32d. Users may take their own computing device 33 home or other working places individually for keeping using. Computing device 33 is a portable computer (notebook computer) for updating application programs or software easily and convenient for using in the system of the present invention.

The KVM switching system of the present invention is a kind of repeater without PS2 interface. The PS2 interface is replaced by USB interface for transmitting and receiving keyboard and cursor control device command signals. Thus, the manufacture cost of the KVM switching device may be reduced.

Having thus described a preferred embodiment of an system that allows for the simultaneous controlling of the video output from a plurality of host computers connected to a computing device and provides for easy access to and intuitive switching between those connected computers, it should be apparent to those skilled in the art that certain advantages of the invention have been achieved. It should also be appreciated that various modifications, adaptations, and alternative embodiments thereof may be made within the scope and spirit of the present invention. The invention is further defined by the following claims.

1. A system for controlling one or more computers comprises one or more of host computers, a KVM (Keyboard/Video/Mouse) switching device and a computing device including a keyboard, a cursor control device, a video display unit and a data processing unit;
wherein the KVM switching device includes a first driver coupled to the host computers; a video codec for converting video signals from the host computer to digital video signals; an USB (Universal Serial Bus) adapter for receiving the digital video signals and transferring the digital video signals to a second driver and receiving and transferring command signals between the first driver and the second driver bi-directionally;
wherein the second driver couples to the computing device for receiving and transmitting the digital video signals and command signals between the computing device and the USB adapter;
wherein the data processing unit manages the digital video signals converted from each of the plurality of host computers for simultaneously displaying the digital video signals on the video display unit.

2. The system as defined in claim 1, wherein the first driver comprises plurality group ports corresponding to the plurality of host computers respectively.

3. The system as defined in claim 2, wherein each of the group ports includes at last one USB port and a video input port.

4. The system as defined in claim 2, wherein each of the group ports further includes an audio input port.

5. The system as defined in claim 3, wherein the video input port is a VGA (Video Graphics Array) port, a DVI (Digital Visual Interface) port, a HDMI (High Definition Multimedia) port or a display port.

6. The system as defined in claim 1, wherein the computing device is a portable computer.

7. The system as defined in claim 1, wherein the command signals comprise cursor control signals and keyboard input signals.

8. The system as defined in claim 1, wherein the video codec is an analog to digital converter.

9. The system as defined in claim 1, wherein the digital video signals are USB compatible digital signals.

10. A system for controlling one or more computers comprises one or more host computers, a KVM (Keyboard/Video/Mouse) switching device and a computing device including a keyboard, a cursor control device, a video display unit and a data processing unit;
wherein the KVM switching device includes a first driver coupled to the host computers; a video codec for converting video signals from the host computers to digital video signals; an USB (Universal Serial Bus) adapter for receiving the digital video signals and transferring the digital video signals to a second driver and receiving and transferring command signals between the first driver and the second driver bi-directionally;
wherein the second driver couples to the computing device for receiving and transmitting the digital video signals and command signals between the computing device and the USB adapter;
wherein the data processing unit manages the digital video signals converted from each of the plurality of host computers for simultaneously displaying the digital video signals on the video display unit;
wherein the first driver comprises plurality group ports corresponding to the plurality of host computers respectively;
wherein each of the group ports includes at last one USB port and a video input port.

11. The system as defined in claim 10, wherein each of the group ports further includes an audio input port.

12. The system as defined in claim 10, wherein the video input port is a VGA (Video Graphics Array) port, a DVI (Digital Visual Interface) port, a HDMI (High Definition Multimedia) port or a display port.

13. The system as defined in claim 10, wherein the computing device is a portable computer.

14. The system as defined in claim 10, wherein the command signals comprise cursor control signals and keyboard input signals.

15. The system as defined in claim 10, wherein the video codec is an analog to digital converter.

16. The system as defined in claim 10, wherein the digital video signals are USB compatible digital signals.
